(19) United States
(12) Patent Application Publication
(10) Pub. No.: US 2025/0368822 A1
(43) Pub. Date: Dec. 4, 2025

(54) RESIN COMPOSITION AND MOLDED ARTICLE

(71) Applicant: ASAHI KASEI KABUSHIKI KAISHA, Tokyo (JP)

(72) Inventors: Koichiro YOSHIDA, Tokyo (JP); Mihoko YAMAMOTO, Tokyo (JP)

(73) Assignee: ASAHI KASEI KABUSHIKI KAISHA, Tokyo (JP)

(21) Appl. No.: 19/220,092

(22) Filed: May 28, 2025

(30) Foreign Application Priority Data
May 31, 2024 (JP) 2024-089416

(51) Int. Cl. C08L 71/12

(52) U.S. Cl. CPC C08L 71/12; C08L 2205/08

(57) ABSTRACT

Provided is a resin composition including (a) (a-1) a polyphenylene ether-based resin, (a-2) a styrene-based resin, and (a-3) one or more compounds selected from a phosphoric acid ester-based compound and a phosphazene compound, or (a-1) a polyphenylene ether-based resin and (a-3) one or more compounds selected from a phosphoric acid ester-based compound and a phosphazene compound, and (b) a polyarylate resin, wherein a number average molecular weight of the (a-1) component is 1.5×10⁴ to 2.5×10⁴, the glass transition temperature of the (a) component is 100° C. to 145° C., the amount of the (a-3) component is 5 to 40 parts by mass, and the amount of the (b) component is 1 to 12 parts by mass, relative to 100 parts by mass of the (a-1) component or 100 parts by mass of a total of the (a-1) component and the (a-2) component.

### TECHNICAL FIELD

The present disclosure relates to a resin composition and a molded article.

### BACKGROUND

Polyphenylene ether-based resins have excellent electrical insulation properties, as well as possessing heat resistance, hydrolysis resistance, and flame retardancy, and are therefore widely used in home appliances, office automation equipment, automobile parts, and the like. Materials used for these applications are required to have high flame retardancy due to issues such as fire hazards, and since flame retardancy can be achieved in polyphenylene ether-based resins by adding phosphorus compounds without using halogen compounds, their value in terms of safety is also increasing.

In recent years, parts have become smaller and their structures have become more complex. Materials for these applications are also required to have good fluidity (moldability) and mechanical properties during injection molding.

In this regard, for example, polyphenylene ether-based resin compositions having excellent fluidity and moldability are disclosed in PTL 1.

### CITATION LIST

### Patent Literature

PTL 1: JP H08-20717 A

### SUMMARY

However, with the increase in fluidity of polyphenylene ether-based resins, there is a problem in that test specimens are more likely to exhibit dripping during combustion in the UL combustion test (UL 94).

In order to obtain a high flame-retardant rating in the UL combustion test (UL 94) regulated by Underwriters Laboratories LLC, it is necessary that there is no ignition of cotton by dripping during the test, and in order to prevent flame spread during actual fires, the drip resistance of the resin is an important issue.

However, in the resin composition disclosed in PTL 1, drip resistance has not been studied.

Accordingly, the present disclosure is directed to providing a resin composition and a molded article that are excellent in flame retardancy and in drip resistance during combustion, as well as in fluidity.

The present inventors have conducted intensive studies to solve the aforementioned issue and, as a result, discovered that the aforementioned issue can be solved by using a composition comprising: (a) (a-1) a polyphenylene ether-based resin, (a-2) a styrene-based resin, and (a-3) at least one compound selected from a phosphoric acid ester-based compound and a phosphazene compound; or (a-1) a polyphenylene ether-based resin and (a-3) at least one compound selected from a phosphoric acid ester-based compound and a phosphazene compound, and (b) a polyarylate resin, wherein the (a-1) component has a specific molecular weight and the (a) component has a specific glass transition temperature, and each component is contained in a specific amount.

Specifically, the present disclosure is as follows.

[1]

A resin composition comprising:
(a) (a-1) a polyphenylene ether-based resin, (a-2) a styrene-based resin, and (a-3) one or more compounds selected from a phosphoric acid ester-based compound and a phosphazene compound, or (a-1) a polyphenylene ether-based resin and (a-3) one or more compounds selected from a phosphoric acid ester-based compound and a phosphazene compound; and
(b) a polyarylate resin,
wherein a number average molecular weight of the (a-1) component is 1.5×10⁴ to 2.5×10⁴,
a glass transition temperature of the (a) component is 100° C. to 145° C., and
an amount of the (a-3) component is 5 to 40 parts by mass, and an amount of the (b) component is 1 to 12 parts by mass, relative to 100 parts by mass of the (a-1) component or 100 parts by mass of a total of the (a-1) component and the (a-2) component.
   [2]

The resin composition according to [1], wherein
when the (a) component includes the (a-1) component and the (a-2) component,
an amount of the (a-1) component is 45 to 85 parts by mass, and an amount of the (a-2) component is 15 to 55 parts by mass, in 100 parts by mass of the total of the (a-1) component and the (a-2) component, and
the amount of the (a-3) component is 10 to 35 parts by mass per 100 parts by mass of the total of the (a-1) component and the (a-2) component.
   [3]

The resin composition according to [1] or [2], wherein
the (a-3) component is a phosphoric acid ester-based compound represented by the following general formula (I) or general formula (II).

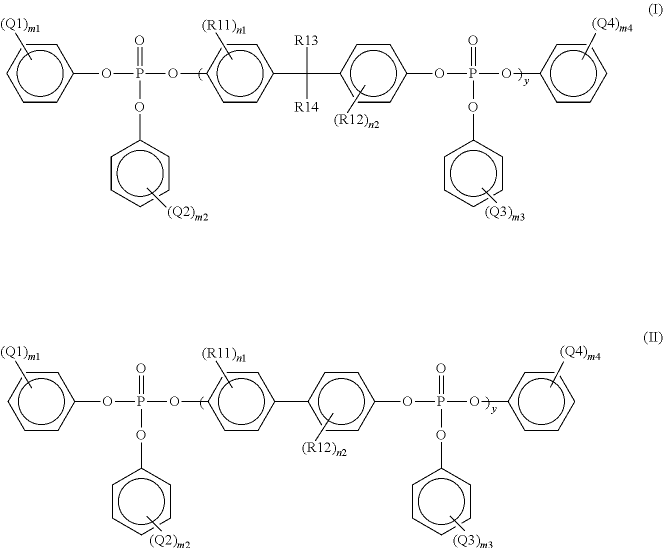

where, in the general formula (I), Q1, Q2, Q3, and Q4 independently represent alkyl groups having 1 to 6 carbon atoms, R11 and R12 represent methyl groups, and R13 and R14 are each independently a hydrogen atom or a methyl group,
in the general formula (II), Q1, Q2, Q3, and Q4 independently represent alkyl groups having 1 to 6 carbon atoms, and R11 and R12 represent methyl groups, and
in the general formula (I) and general formula (II), y is an integer of 1 or more, n1 and n2 independently represent integers of 0 to 2, and m1, m2, m3, and m4 independently represent integers of 0 to 3.
   [4]

The resin composition according to any one of [1] to [3], further comprising (c) an elastomer.

[5]

The resin composition according to any one of [1] to [4], further comprising (d) a compatibilizer.

[6]

The resin composition according to any one of [1] to [5], wherein a melt flow rate measured at a measurement temperature of 250° C. under a load of 10 kg in accordance with ISO 1133 is 10 g/10 min or more.

[7]

The resin composition according to any one of [1] to [6], wherein the amount of the (a) component is 70 to 99 parts by mass in 100 parts by mass of the resin composition.

[8]

The resin composition according to any one of [1] to [7], wherein a total amount of the (a) component and the (b) component is 70 to 100 parts by mass in 100 parts by mass of the resin composition.

[9]

A molded article comprising the resin composition according to any one of [1] to [8].

According to the present disclosure, it is possible to provide a resin composition and a molded article that are excellent in flame retardancy and in drip resistance during combustion, as well as in fluidity.

### DETAILED DESCRIPTION

The following provides a detailed description of embodiments for embodying the present disclosure (hereinafter referred to as “the present embodiment”). It should be noted that the present embodiment set forth below is an illustrative embodiment for describing the present disclosure and is not intended to limit the present disclosure to the following matter. The present disclosure can be implemented with appropriate modifications that are within the scope of the essence thereof.

### Definitions

In this specification, (a-1) a polyphenylene ether-based resin, (a-2) a styrene-based resin, (a-3) at least one compound selected from a phosphoric acid ester-based compound and a phosphazene compound, (b) a polyarylate resin, (c) an elastomer, and (d) a compatibilizer may be referred to as the (a-1) component, the (a-2) component, the (a-3) component, the (b) component, the (c) component, and the (d) component, respectively. In addition, in this specification, the (a-1) component, the (a-2) component, and the (a-3) component collectively, or the (a-1) component and the (a-3) component collectively, may be referred to as the (a) component.

### <Resin Composition>

A resin composition of the present embodiment contains:
(a) (a-1) a polyphenylene ether-based resin, (a-2) a styrene-based resin, and (a-3) one or more compounds selected from a phosphoric acid ester-based compound and a phosphazene compound, or (a-1) a polyphenylene ether-based resin and (a-3) one or more compounds selected from a phosphoric acid ester-based compound and a phosphazene compound; and
(b) a polyarylate resin,
wherein the number average molecular weight of the (a-1) component is 1.5×10⁴ to 2.5×10⁴,
the glass transition temperature of the (a) component is 100° C. to 145° C.,
the amount of the (a-3) component is 5 to 40 parts by mass, and
the amount of the (b) component is 1 to 12 parts by mass,
relative to 100 parts by mass of the (a-1) component or 100 parts by mass of a total of the (a-1) component and the (a-2) component.

The above-described resin composition is excellent in flame retardancy and in drip resistance during combustion, as well as in fluidity.

The resin composition of the present embodiment preferably has a melt flow rate (MFR) of 5 g/10 min or more, as measured in accordance with ISO 1133 at a measurement temperature of 250° C. and under a load of 10 kg. When the melt flow rate of the resin composition is 5 g/10 min or more, an excellent fluidity is exhibited. From a similar perspective, the melt flow rate of the resin composition of the present embodiment is more preferably 10 g/10 min or more, even more preferably 15 g/10 min or more, and still even more preferably 20 g/10 min or more. The melt flow rate may also be 60 g/10 min or less, or 50 g/10 min or less.

The resin composition of the present embodiment preferably has a Charpy impact strength of 10 kJ/m² or more from the perspective of impact resistance. From a similar perspective, the Charpy impact strength is more preferably 15 kJ/m² or more, even more preferably 20 kJ/m² or more. The Charpy impact strength may also be 50 kJ/m² or less.

It should be noted that the Charpy impact strength of the resin composition is a value measured in accordance with ISO 179, with a notched specimen having the dimensions specified in ISO 179.

((a) (a-1) Polyphenylene ether-based resin, (a-2) styrene-based resin, and (a-3) at least one compound selected from a phosphoric acid ester-based compound and a phosphazene compound, or (a-1) polyphenylene ether-based resin and (a-3) at least one compound selected from a phosphoric acid ester-based compound and a phosphazene compound ((a) component))

The (a) component of the present embodiment is (a-1) a polyphenylene ether-based resin, (a-2) a styrene-based resin, and (a-3) at least one compound selected from a phosphoric acid ester-based compound and a phosphazene compound, or (a-1) a polyphenylene ether-based resin and (a-3) at least one compound selected from a phosphoric acid ester-based compound and a phosphazene compound. In other words, the (a) component is a component including (a-1) a polyphenylene ether-based resin, (a-2) a styrene-based resin, and (a-3) at least one compound selected from a phosphoric acid ester-based compound and a phosphazene compound, or a component including (a-1) a polyphenylene ether-based resin and (a-3) at least one compound selected from a phosphoric acid ester-based compound and a phosphazene compound.

Two components may be contained in the (a) component, or two or more components may be contained in the (a) component.

In the present embodiment, the glass transition temperature of the (a) component is 100° C. to 145° C., preferably 100° C. to 140° C., and more preferably 100° C. to 135° C. or less. The fluidity tends to increase as the glass transition temperature decreases; however, dripping becomes more likely to occur. A glass transition temperature of 100° C. or higher tends to provide excellent drip resistance, while a temperature of 145° C. or lower tends to ensure excellent fluidity.

It should be noted that the glass transition temperature of the (a) component is a value measured using a DSC measuring device, by heating it from 50° C. to 300° C. at a heating rate of 20° C. per minute in a nitrogen atmosphere, then cooling down to 50° C. at 20° C. per minute, and subsequently heating again at a heating rate of 20° C. per minute.

—(a-1) Polyphenylene Ether-Based Resin ((a-1) Component)—

As the (a-1) component contained in the resin composition of the present embodiment, both a homopolymer composed of the structural unit represented by the general formula (III), and a copolymer having the structural unit of the general formula (III) (hereinafter, sometimes simply referred to as “polyphenylene ether”) can be used.

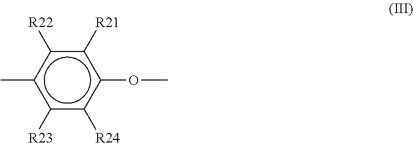

In the general formula (III), O represents an oxygen atom, and R²¹ to R²⁴ independently represent any one selected from the group consisting of a hydrogen atom, a halogen atom, a primary or secondary alkyl group having 1 to 8 carbon atoms, a phenyl group, a haloalkyl group, an aminoalkyl group, a hydrocarbonoxy group, and a halohydrocarbonoxy group (provided that at least two carbon atoms separate the halogen atom and the oxygen atom).

Examples of homopolymers that may serve as the polyphenylene ether-based resin include, but are not limited to, poly(2,6-dimethyl-1,4-phenylene ether), poly(2-methyl-6-ethyl-1,4-phenylene ether), poly(2-methyl-6-phenyl-1,4-phenylene ether), and poly(2,6-dichloro-1,4-phenylene ether).

Examples of copolymers that may serve as the polyphenylene ether-based resin include, but are not limited to, copolymers of 2,6-dimethylphenol with other phenols (for example, a copolymer with 2,3,6-trimethylphenol or a copolymer with 2-methyl-6-butylphenol).

Of these examples, poly(2,6-dimethyl-1,4-phenylene ether), a copolymer of 2,6-dimethylphenol and 2,3,6-trimethylphenol, or a mixture thereof is preferable as the polyphenylene ether-based resin from a viewpoint of balance of mechanical properties and productivity.

The method by which the polyphenylene ether-based resin used in the present embodiment is produced may be, but is not limited to, a commonly known production method such as described in U.S. Pat. No. 3,306,874 A, 3,306,875 A, 3,257,357 A, 3,257,358 A, JP S50-51197 A, JP S52-17880 B, and JP S63-152628 A.

The reduced viscosity of the polyphenylene ether-based resin is preferably in the range of 0.25 to 0.70 dL/g from the perspective of balancing drip resistance and fluidity. The reduced viscosity is more preferably in the range of 0.30 to 0.65 dL/g, and even more preferably in the range of 0.40 to 0.60 dL/g. When the reduced viscosity is 0.25 dL/g or more, excellent drip resistance is exhibited. Moreover, excellent fluidity is achieved when the reduced viscosity is 0.65 dL/g or less. In the present embodiment, the reduced viscosity of the polyphenylene ether-based resin is a value measured in a 0.5 g/dL chloroform solution at 30° C. using an Ubbelohde-type viscometer.

It should be noted that a mixture of two or more polyphenylene ether-based resins having different reduced viscosities can also preferably be used in the present embodiment.

Furthermore, the (a-1) polyphenylene ether-based resin in the present embodiment may include a modified polyphenylene ether that is fully or partially modified. The term “modified polyphenylene ether” refers to a polyphenylene ether that has been modified by a modifying compound that includes at least one carbon-carbon double bond or triple bond in its molecular and also includes at least one group selected from the group consisting of a carboxyl group, an acid anhydride group, an amino group, a hydroxy group, and a glycidyl group (hereinafter, also referred to simply as a “modifying compound”). One type of modifying compound may be used individually, or two or more types of modifying compounds may be used together.

As the method for producing a modified polyphenylene ether, although not limited to the following, examples include: (1) a method of reacting with a modifying compound at a temperature in the range of 100° C. or higher and below the glass transition temperature of the polyphenylene ether, in the presence or absence of a radical initiator; (2) a method of melt-kneading and reacting with a modifying compound at a temperature in the range of the glass transition temperature of the polyphenylene ether or higher and 360° C. or lower, and (3) a method of reacting polyphenylene ether with a modifying compound in solution at a temperature below the glass transition temperature of the polyphenylene ether. Among these methods for producing modified polyphenylene ether, the methods (1) or (2) are preferable from the perspective of productivity.

Next, the modifying compound used for producing the modified polyphenylene ether will be described. The modifying compound used to produce the modified polyphenylene ether is a modifying compound that includes at least one carbon-carbon double bond or triple bond in the molecular thereof and also includes at least one group selected from the group consisting of a carboxyl group, an acid anhydride group, an amino group, a hydroxy group, and a glycidyl group.

Examples of the modifying compound that includes a carbon-carbon double bond in the molecule thereof and includes a carboxyl group or an acid anhydride group include, but are not limited to, unsaturated dicarboxylic acids such as maleic acid, fumaric acid, chloromaleic acid, and cis-4-cyclohexene-1,2-dicarboxylic acid. In particular, fumaric acid, maleic acid, and maleic anhydride are preferable, and fumaric acid and maleic anhydride are more preferable as the modifying compound from a viewpoint of reactivity with a polyphenylene ether-based resin.

Moreover, a compound in which one or two of the two carboxyl groups included in any of the above-described unsaturated dicarboxylic acids are esterified can be used as a modifying compound.

Examples of the modifying compound that includes a carbon-carbon double bond in the molecule thereof and includes a glycidyl group include, but are not limited to, allyl glycidyl ether, glycidyl acrylate, glycidyl methacrylate, and epoxidized natural fats and oils. Of these examples, glycidyl acrylate and glycidyl methacrylate are preferable.

Examples of the modifying compound that includes a carbon-carbon double bond in the molecule thereof and includes a hydroxy group include, but are not limited to, unsaturated alcohols having a general formula CₙH₂ₙ₋₁OH or CₙH₂ₙ₋₃OH (where n is a positive integer), such as allyl alcohol, 4-pentene-1-ol, and 1,4-pentadien-3-ol, and unsaturated alcohols having a general formula of CₙH₂ₙ₋₅OH or CₙH₂ₙ₋₇OH (where n is a positive integer).

One of the modifying compounds described above may be used individually, or two or more of the modifying compounds described above may be used in combination.

The amount of the modifying compound added when producing the modified polyphenylene ether is preferably 0.1 to 10 parts by mass, more preferably 0.3 to 5 parts by mass, and even more preferably 0.5 to 3 parts by mass per 100 parts by mass of the polyphenylene ether from the perspective of efficiency of modification, for example.

When the modified polyphenylene ether is produced using a radical initiator, the amount of the radical initiator added is preferably 0.001 to 1 part by mass, more preferably 0.01 to 0.5 parts by mass, and even more preferably 0.05 to 0.3 parts by mass per 100 parts by mass of the polyphenylene ether, from the perspective of the degree of modification and balance of physical properties.

Moreover, the addition rate of the modifying compound to the modified polyphenylene ether is preferably 0.01 to 5 mass %, more preferably 0.05 to 3 mass %, and even more preferably 0.1 to 1 mass % per 100 mass % of the modified polyphenylene ether.

The unreacted modifying compound and polymers of the modifying compound may remain in the modified polyphenylene ether. When unreacted modifying compound and polymers of the modifying compounds remain, their amount is preferably less than 5 mass %, more preferably 3 mass % or less, and even more preferably 1 mass % or less.

In the present embodiment, the number average molecular weight of the (a-1) component is 1.5×10⁴ to 2.5×10⁴, preferably 1.6×10⁴ to 2.4×10⁴, and more preferably 1.8×10⁴ to 2.3×10⁴. The fluidity tends to increase as the molecular weight increase; however, dripping becomes more likely to occur. A number average molecular weight of 1.5×10⁴ or more tends to provide excellent drip resistance, while a number average molecular weight of 2.5×10⁴ or less tends to ensure excellent fluidity.

The number average molecular weight of the (a-1) component is a value determined by gel permeation chromatography.

—(a-2) Styrene-Based Resin ((a-2) Component)—

In the present embodiment, the (a-2) styrene-based resin ((a-2) component) refers to a copolymer obtained by polymerizing a styrene-based compound, or a styrene-based compound and a compound copolymerizable with the styrene-based compound (hereinafter, the “compound copolymerizable with the styrene-based compound” may be simply referred to as “copolymerizable compound”), in the presence or absence of a rubbery polymer. Styrene-based resins that also fall under the category of the (c) elastomer and the (d) compatibilizer component described later are not classified as the (a-2) component, but rather as the (c) component or (d) component, respectively.

Examples of the styrene-based compound include, but are not limited to, styrene, α-methylstyrene, 2,4-dimethylstyrene, monochlorostyrene, p-methylstyrene, p-tert-butylstyrene, and ethylstyrene, for example. Of these, styrene is preferable as the styrene-based compound.

Examples of styrene-based compound and the compound that is copolymerizable with the styrene-based compound (copolymerizable compound) include, but are not limited to, methacrylic acid esters such as methyl methacrylate and ethyl methacrylate; unsaturated nitrile compounds such as acrylonitrile and methacrylonitrile; and acid anhydrides such as maleic anhydride.

The amount of the copolymerizable compound is preferably 20 mass % or less, and more preferably 15 mass % or less, per 100 mass % of the total of the styrene-based compound and the copolymerizable compound.

Examples of the above-described rubbery polymer include conjugated diene rubbers, copolymers of a conjugated diene and an aromatic vinyl compound, and ethylene-propylene copolymer rubbers. Of these examples, polybutadiene, a styrene-butadiene random copolymer, a styrene-butadiene block copolymer, or a rubber component obtained through substantially complete or complete hydrogenation of any thereof (for example, a rubber component having a hydrogenation rate of 50% to 100%) is preferable as the rubbery polymer.

Example of the (a-2) component include, but is not limited to, homopolystyrene, rubber-modified polystyrene (HIPS), styrene-acrylonitrile copolymer (AS resin), styrene-rubbery polymer-acrylonitrile copolymer (ABS resin), or another styrene copolymer, for example. Among these, from the perspective of compatibility with the polyphenylene ether-based resin, at least one selected from the group consisting of homopolystyrene and rubber-modified polystyrene (HIPS) is preferable as the (a-2) component.

((a-3) One or More Compounds Selected from Hosphoric Acid Ester-Based Compound and Phosphazene Compound ((a-3) Component))

The resin composition of the present embodiment contains one or more compounds selected from a phosphoric acid ester-based compound and a phosphazene compound.

The above-described modifying compounds may be used alone or in a combination of two or more.

As the (a-3) component, phosphoric acid ester-based compounds and/or phosphazene compounds can be used. Among these, from the perspective of balance between flame retardancy and fluidity, a phosphoric acid ester-based compound is preferably included.

Examples of the (c) phosphoric acid ester-based compound include, but are not limited to, triphenyl phosphate, tris(nonylphenyl) phosphate, resorcinol bis(diphenyl phosphate), resorcinol bis[di(2,6-dimethylphenyl) phosphate], 2,2-bis{4-[bis(phenoxy)phosphoryloxy]phenyl}propane, and 2,2-bis{4-[bis(methylphenoxy)phosphoryloxy]phenyl}propane. Further examples of the (c) phosphoric acid ester flame retardant other than those described above include phosphoric acid ester flame retardants such as trimethyl phosphate, triethyl phosphate, tributyl phosphate, trioctyl phosphate, tributoxyethyl phosphate, tricresyl phosphate, cresyl phenyl phosphate, octyl diphenyl phosphate, and diisopropyl phenyl phosphate; monophosphoric acid ester-based compounds such as diphenyl-4-hydroxy-2,3,5,6-tetrabromobenzyl phosphonate, dimethyl-4-hydroxy-3,5-dibromobenzyl phosphonate, diphenyl-4-hydroxy-3,5-dibromobenzyl phosphonate, tris(chloroethyl) phosphate, tris(dichloropropyl) phosphate, tris(chloropropyl) phosphate, bis(2,3-dibromopropyl)-2,3-dichloropropyl phosphate, tris(2,3-dibromopropyl)phosphate, bis(chloropropyl)monooctyl phosphate, hydroquinonyl diphenyl phosphate, phenyl nonylphenylhydroquinonyl phosphate, and phenyl dinonylphenyl phosphate; and aromatic condensed phosphoric acid ester compounds. Of these, aromatic condensed phosphoric acid ester-based compounds are preferable due to having little gas release during processing and excellent thermal stability, etc.

The aromatic condensed phosphoric acid ester-based compound may be a compound that is generally commercially available, examples of which include, but are not limited to, trade names “CR741”, “CR733S”, “PX200”, and “E890” available from Daihachi Chemical Industry Co., Ltd. Co., Ltd., and trade names “FP600”, “FP700”, and “FP800” available from Adeka Corporation.

The (a-3) component used in the present embodiment is preferably an aromatic condensed phosphate ester represented by the following general formula (I) or (II), with the aromatic condensed phosphate ester represented by general formula (I) being more preferred.

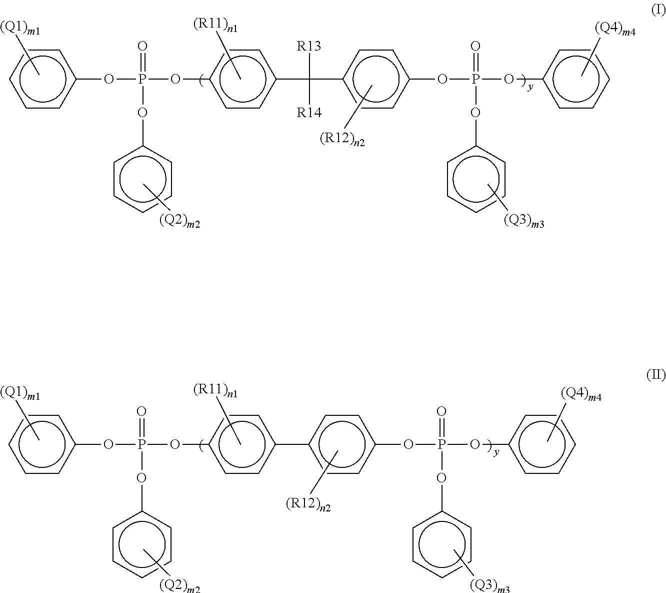

In the general formula (I), Q1, Q2, Q3, and Q4 independently represent alkyl groups having 1 to 6 carbon atoms, R11 and R12 represent methyl groups, and R13 and R14 are each independently a hydrogen atom or a methyl group.

In the general formula (II), Q1, Q2, Q3, and Q4 independently represent alkyl groups having 1 to 6 carbon atoms, and R11 and R12 represent methyl groups.

In the general formula (I) and general formula (II), y is an integer of 1 or more, n1 and n2 independently represent integers of 0 to 2, and m1, m2, m3, and m4 independently represent integers of 0 to 3.

In General Formulas (I) and (II), y is preferably an integer of 1, 2, or 3, and more preferably 1.

In one preferred example of the general formula (I), m1, m2, m3, m4, n1, and n2 are 0, R13 and R14 are methyl groups, and y is 1, 2, or 3. In another preferred example of the general formula (I), Q1, Q2, Q3, Q4, R13, and R14 are methyl groups, n1 and n2 are 0, m1, m2, m3, and m4 are 1, 2, or 3, and y is 1, 2, or 3.

In the (a-3) component, it is preferable that the aromatic condensed phosphoric acid ester of the formula (I) is contained in an amount of 50 to 100 mass % relative to 100 mass % of the (a-3) component.

In one preferred example of the general formula (II), m1, m2, m3, m4, n1, and n2 are 0, and y is 1, 2, or 3. Furthermore, in another preferred example of the general formula (II), Q1, Q2, Q3, and Q4 are methyl groups, n1 and n2 are 0, m1, m2, m3, and m4 are 1, 2, or 3, and y is 1, 2, or 3.

In the (a-3) component, it is preferable that the aromatic condensed phosphoric acid ester of the formula (II) is contained in an amount of 50 to 100 mass % relative to 100 mass % of the (a-3) component.

The acid value of the aromatic condensed phosphoric acid ester compound is more preferably 0.1 or less (which is a value obtained in accordance with JIS K2501).

### ((b) Polyarylate Resin ((b) Component))

The resin composition of the present embodiment contains a (b) polyarylate resin ((b) component).

The (b) polyarylate resin ((b) component) in the present embodiment is a polymer having an aromatic ring and an ester bond, and is also referred to as a polyaryl ester, as structural units.

As the polyarylate resin, a polyarylate having repeating units represented by the following general formula (IV), which is composed of bisphenol A and terephthalic acid and/or isophthalic acid, is preferably used.

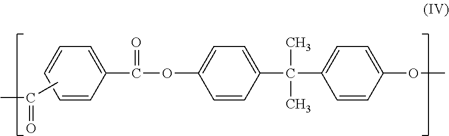

Commercial products may also be used as the polyarylate resin of the (b) component, and examples include “U-Polymer” manufactured by Unitika Ltd.

The molecular weight of the (b) polyarylate resin is preferably a number average molecular weight in terms of polystyrene measured by gel permeation chromatography (GPC) of 5,000 to 300,000, more preferably 10,000 to 300,000, and even more preferably 10,000 to 100,000. When the number average molecular weight of the polyarylate resin is 5,000 or more, the heat resistance of the molded article tends to be improved and the mechanical strength of the resin tends to be increased. When the average molecular weight is 300,000 or less, the fluidity of the resin tends to improve.

The number average molecular weight in terms of polystyrene can be specifically obtained by using GPC under conditions in which chloroform is used as the solvent and the column temperature is 40° C., from a curve of retention time vs. molecular weight for standard polystyrene that has been measured in advance under the same conditions. In measurements, the concentration of the chloroform solution of the polyarylate resin is 1 g/liter. Furthermore, it is preferable to conduct measurements using a UV absorption detector at about 280 nm.

### ((c) Elastomer ((c) Component))

The resin composition of the present embodiment can further contain (c) an elastomer.

A preferred (c) elastomer is a block copolymer of an aromatic vinyl compound (for example, styrene) and a conjugated diene compound, and more preferably a hydrogenated block copolymer obtained by hydrogenating the above-described block copolymer. It is to be noted that, as described above, styrene-based compounds contained in the elastomer shall not be included in the (a-2) component.

The hydrogenation rate of conjugated diene compound-derived unsaturated bonds resulting from the hydrogenation is preferably 60% or more, more preferably 80% or more, and even more preferably 95% or more from a viewpoint of thermal stability.

In a case in which the pre-hydrogenation block copolymer is a block copolymer of styrene and a conjugated diene compound, the structure of the block copolymer may be S-B-S, S-B-S-B, (S-B-)₄-S, S-B-S-B-S, or the like, where S represents a styrene block chain and B represents a diene compound block chain, for example.

The microstructure of a polymer block of the conjugated diene compound (i.e., the bonding format of the conjugated diene compound) can be freely selected. The vinyl bond content (total of 1,2-vinyl bonds and 3,4-vinyl bonds) in a conjugated diene compound polymer block is preferably 2% to 60%, and more preferably 8% to 40% relative to the total bond content (total of 1,2-vinyl bonds, 3,4-vinyl bonds, and 1,4-conjugated bonds) in the conjugated diene compound polymer.

The number average molecular weight of the (c) component is preferably 100,000 to 400,000, more preferably 150,000 to 350,000, and even more preferably 200,000 to 300,000. When the number average molecular weight of the (c) component is 100,000 or more, a resin composition excellent in impact resistance is obtained. Furthermore, when the number average molecular weight of the (c) component is 400,000 or less, the resin composition becomes excellent in fluidity.

The number average molecular weight in terms of polystyrene can be specifically obtained by using GPC under conditions in which chloroform is used as the solvent and the column temperature is 40° C., from a curve of retention time vs. molecular weight for standard polystyrene that has been measured in advance under the same conditions.

In a case in which the (c) component includes a styrene polymer block chain, the number average molecular weight of at least one styrene polymer block chain is preferably 15,000 or more. The number average molecular weight of at least one styrene polymer block chain is more preferably 20,000 to 50,000. It is even more preferable that every styrene polymer block chain has a number average molecular weight of 15,000 or more.

Although no specific limitations are placed on the proportion constituted by a styrene polymer block chain in the (c) component in a case in which the (c) component includes a styrene polymer block chain so long as the number average molecular weight of the styrene polymer block chain is within any of the ranges set forth above, this proportion is preferably 10 mass % to 70 mass %, more preferably 20 mass % to 50 mass %, and even more preferably 30 mass % to 40 mass % from a viewpoint of impact resistance.

As the (c) component, two or more hydrogenated block copolymers having different compositions or structures can also be used in combination. Examples include combined use of a hydrogenated block copolymer having a bound styrene polymer block content of 50 mass % or more and a hydrogenated block copolymer having a bound styrene polymer block content of 30 mass % or less, combined use of hydrogenated block copolymers having different molecular weights, and combined use of a hydrogenated random block copolymer obtained through hydrogenation of a block copolymer that includes a random copolymer block of styrene and a conjugated diene compound and a block copolymer of styrene and a conjugated diene compound such as described.

It is to be noted that the “content of bound styrene polymer block” refers to the proportion occupied by the styrene polymer block chains in the (c) component.

### ((d) Compatibilizer ((d) Component))

The resin composition of the present embodiment can further contain (d) a compatibilizer from the perspective of finely dispersing the (b) component in the (a) component. When the resin composition of the present embodiment includes the (d) component, a resin composition excellent in drip resistance and impact resistance is obtained.

Examples of the (d) compatibilizer include, but are not limited thereto, for example, styrene-based copolymers having a glycidyl group.

Examples of the styrene-based copolymers having a glycidyl group include, but are not limited thereto, for example, copolymers of a glycidyl group-containing unsaturated monomer and a styrene-based monomer can be mentioned.

Examples of the glycidyl group-containing unsaturated monomer include glycidyl esters of unsaturated carboxylic acids and glycidyl ethers of unsaturated compounds. Examples of the glycidyl esters of unsaturated carboxylic acids include, for example, glycidyl acrylate, glycidyl methacrylate, and monoglycidyl ester of itaconic acid. Also, examples of the unsaturated glycidyl ethers include, for example, vinyl glycidyl ether, allyl glycidyl ether, 2-methylallyl glycidyl ether, and methacryl glycidyl ether.

Examples of the styrene-based monomers include styrene, methylstyrene, and dimethylstyrene, ethylstyrened.

These styrene-based copolymers having a glycidyl group may be used alone as a single component or in combination of two or more.

From the perspective of further improving compatibility with the (a) component, the styrene monomer units are contained in an amount of preferably 65 mass % or more, and more preferably 75 to 95 mass %.

### (Other Flame Retardants)

The resin composition of the present embodiment may contain various flame retardants and flame-retardant aids that have been conventionally known. Examples of other flame retardants include, for example, phosphinic acid salts, alkaline earth metal hydroxides such as magnesium hydroxide, aluminum hydroxide, alkali metal hydroxides, zinc borate compounds, and zinc stannate compounds.

### (Additives)

To further impart other properties to the resin composition of the present embodiment, additives such as resins other than the (a) component and the (b) component, plasticizers, stabilizers such as antioxidants and ultraviolet absorbers, antistatic agents, mold release agents, dyes, pigments, fillers, reinforcing agents, and spreading agents can be added within a range not where the effects of the present disclosure are not impaired.

### (Content of Each Component)

In the resin composition of the present embodiment, the amount of the (a-3) component is 5 to 40 parts by mass and the amount of the (b) component is 1 to 12 parts by mass, relative to 100 parts by mass of the (a-1) component or 100 parts by mass of the total of the (a-1) component and the (a-2) component.

The components constituting the (a) component may be a mixture resin of the (a-1) component and the (a-2) component and the (a-3) component, or the (a-1) component and the (a-3) component.

In the case where the (a) component is a mixture resin of the (a-1) component and the (a-2) component, it is preferable that the amount of the (a-1) component is 45 to 85 parts by mass and the amount of the (a-2) component is 15 to 55 parts by mass, it is more preferable that the amount of the (a-1) component is 50 to 75 parts by mass and the amount of the (a-2) component is 25 to 50 parts by mass, it is even more preferable that the amount of the (a-1) component is 50 to 70 parts by mass and the amount of the (a-2) component is 30 to 50 parts by mass, in 100 parts by mass of the total of the (a-1) component and the (a-2) component. When the amount of the (a-1) component is 45 parts by mass or more in 100 parts by mass of the total of the (a-1) component and the (a-2) component, the drip resistance tends to be more excellent, and when the amount of the (a-1) component is 85 parts by mass or less, the fluidity tends to be more excellent.

As described above, the amount of the (a-3) component is 5 to 40 parts by mass relative to 100 parts by mass of the (a-1) component or 100 parts by mass of the total of the (a-1) component and the (a-2) component. The amount of the (a-3) component is preferably 10 to 35 parts by mass, and more preferably 15 to 30 parts by mass, relative to 100 parts by mass of the (a-1) component or 100 parts by mass of the total of the (a-1) component and the (a-2) component. When the amount of the (a-3) component is 5 parts by mass or more, the resin composition tends to be excellent in flame retardancy and fluidity, and when the amount of the (a-3) component is 40 parts by mass or less, the resin composition tends to be more excellent in drip resistance.

As described above, the amount of the (b) component is 1 to 12 parts by mass relative to 100 parts by mass of the (a-1) component or 100 parts by mass of the total of the (a-1) component and the (a-2) component. The amount of the (b) component is preferably 1.5 to 10 parts by mass, more preferably 2 to 8 parts by mass, and even more preferably 2 to 5 parts by mass, relative to 100 parts by mass of the (a-1) component or 100 parts by mass of the total of the (a-1) component and the (a-2) component. When the amount of the (b) component is 1 part by mass or more, the resin composition tends to be more excellent in drip resistance, and when the amount of the (b) component is 12 parts by mass or less, the resin composition tends to be more excellent in fluidity and impact resistance.

From the perspective of achieving excellent flame retardancy and drip resistance, the amount of the (a) component is preferably 70 to 99 parts by mass, more preferably 75 to 99 parts by mass, and even more preferably 80 to 99 parts by mass in 100 parts by mass of the resin composition of the present embodiment. Furthermore, the total amount of the (a) component and the (b) component is preferably 70 to 100 parts by mass, more preferably 75 to 100 parts by mass, and even more preferably 80 to 100 parts by mass, in 100 parts by mass of the resin composition of the present embodiment. By adopting the above-described aspect, it becomes possible to suppress the content of crystalline resins, which are likely to drip in a temperature range higher than the melting point thereof, and as a result, the flame retardancy and drip resistance of the resin composition are improved.

When the (c) component is included, the amount of the (c) component is preferably 50 parts by mass or less, more preferably 40 parts by mass or less, and even more preferably 30 parts by mass or less, relative to 100 parts by mass of the (a-1) component or 100 parts by mass of the total of the (a-1) component and the (a-2) component. When the amount of the (c) component is 50 parts by mass or less, the resin composition tends to be more excellent in flame retardancy. When the (c) component is included, it is preferable that the total amount of the (a) component, the (b) component, and the (c) component is 80 to 100 parts by mass, more preferably 85 to 100 parts by mass, and even more preferably 90 to 100 parts by mass, in 100 parts by mass of the resin composition of the present embodiment. By adopting the above-described aspect, the composition becomes excellent in flame retardancy and drip resistance.

When the (d) component is included, the amount of the (d) component is preferably 8 parts by mass or less, more preferably 5 parts by mass or less, and even more preferably 3 parts by mass or less, relative to 100 parts by mass of the (a-1) component or 100 parts by mass of the total of the (a-1) component and the (a-2) component. When the amount of the (d) component is 8 parts by mass or less, the resin composition tends to be more excellent in fluidity. When the (d) component is included, the total amount of the (a) component, the (b) component, and the (d) component is preferably 70 to 100 parts by mass, more preferably 75 to 100 parts by mass, and even more preferably 80 to 100 parts by mass, in 100 parts by mass of the resin composition of the present embodiment. By adopting the above-described aspect, the composition becomes excellent in flame retardancy and drip resistance.

When the (c) component and the (d) component are included, the total amount of the (a), (b), (c), and (d) components in 100 parts by mass of the resin composition of the present embodiment is preferably 80 to 100 parts by mass, more preferably 85 to 100 parts by mass, and even more preferably 90 to 100 parts by mass. By adopting the above-described aspect, the composition becomes excellent in flame retardancy and drip resistance.

When other flame retardants are included, the amount of the other flame retardants is preferably 40 parts by mass or less, more preferably 30 parts by mass or less, and even more preferably 20 parts by mass or less, relative to 100 parts by mass of the (a-1) component or 100 parts by mass of the total of the (a-1) component and the (a-2) component, from the perspective of fluidity and appearance. When the amount of the other flame retardants is 40 parts by mass or less, the fluidity and appearance tend to be excellent.

The total amount of the above-described additives is preferably 15 mass % or less, more preferably 10 mass % or less, and even more preferably 5 mass % or less, relative to 100 mass % of the resin composition.

### (Production Method of Resin Composition)

The resin composition of the present embodiment can be produced, for example, by melt-kneading the (a) component and the (b) component, and optionally the (c) component and the (d) component, using a twin-screw extruder.

The twin screw extruder may, for example, be a twin screw extruder of the trade name: “ZSK” series manufactured by Coperion GmbH, trade name: “TEM” series manufactured by Toshiba Machine Co., Ltd., or trade name: “TEX” series manufactured by The Japan Steel Works, Ltd.

The melt-kneading temperature and the screw rotation speed in the method for producing the resin composition of the present embodiment can be appropriately selected from the ranges of a melt-kneading temperature of 200 to 370° C. and a screw rotation speed of 100 to 1200 rpm.

Examples of the raw material feeding apparatuses for feeding the raw materials to the twin-screw extruder include, for example, loss-in-weight feeders, single screw feeders, twin-screw feeders, table feeders, and rotary feeders. Among these, from the perspective of minimizing fluctuations and errors in raw material feeding, a loss-in-weight feeder is preferable.

In cases where a liquid raw material is fed, kneading can be performed by feeding the liquid raw material directly into the cylinder system using a liquid-feeding pump or the like to the cylinder portion of the extruder. The liquid-feeding pump are not particularly limited, and examples include, for example, gear pumps and flange-type pumps. Among these, a gear pump is preferable. Furthermore, it is more preferable to heat, using a heater or the like, parts that serve as the flow path of the liquid raw material, such as the tank for storing the liquid raw material used in the liquid-feeding pump, the piping between the tank and the pump, and the piping between the pump and the extruder cylinder. This is preferable from the perspective of operability and the like because the viscosity of the liquid raw material can be reduced, thereby reducing the load applied to the liquid-feeding pump.

### (Applications)

The resin composition of the present disclosure can be used as a material for electrical and electronic parts, home appliances, office automation equipment, and the like, for example.

### <Molded Article>

A molded article of the present embodiment contains the resin composition of the present embodiment. Since the molded article of the present embodiment contains the resin composition of the present embodiment, it exhibits excellent flame retardancy and drip resistance during combustion.

The resin composition of the present embodiment may be molded to obtain a molded article.

As the molding method, for example, known molding methods such as injection molding, blow molding, extrusion molding, sheet molding, and film molding can be used, and injection molding is particularly preferable.

Examples of injection molding machines include, for example, trade name: “PS-40” manufactured by Nissei Plastic Industrial, Co. Ltd.

The melt temperature and mold temperature in the molding method of the resin composition of the present embodiment can be appropriately selected from the ranges of a melt temperature of 150 to 350° C. and a mold temperature of 5 to 150° C.

The molded article can be used as various molded articles and is applicable in a wide range of fields such as industrial parts, electric and electronic components, housings for office equipment, automobile parts, and precision components.

### EXAMPLES

The following provides a more detailed description of the present disclosure through specific examples and comparative examples. However, the present disclosure is not limited to the following examples.

### <Raw Materials>

Raw materials used in resin compositions of the examples and comparative examples were as indicated below.

### (a) Component

—(a-1) Component—
(a-1-1): Poly(2,6-dimethyl-1,4-phenylene ether) having an reduced viscosity of 0.5 dL/g
(a-1-2): Poly(2,6-dimethyl-1,4-phenylene ether) having an reduced viscosity of 0.4 dL/g
   —(a-2) Component—
(a-2-1) Polystyrene (trade name: “GPPS 680” manufactured by PS Japan Corporation)
(a-2-2): Rubber-modified polystyrene (trade name: “CT60” manufactured by Petrochemical)
   —(a-3) Component—
(a-3-1): Aromatic condensed phosphoric acid ester compound (trade name: “E890” manufactured by Daihachi Chemical Industry Co., Ltd.)
(a-3-2): Aromatic phosphoric acid ester compound (trade name: “TPP” manufactured by Daihachi Chemical Industry Co., Ltd.)
(a-3-3): Phosphazene compound (trade name: “Rabitle FP-110” manufactured by Fushimi Pharmaceutical)

### (b) Component

Polyarylate resin (trade name: “U-Polymer” manufactured by Unitika Ltd.)

### (c) Component

Hydrogenated block copolymer (trade name: “TAIPOL 6151” manufactured by TSRC)

### (d) Component

Styrene-based glycidyl methacrylate (trade name: “Marproof G-1005S” manufactured by NOF Corporation)

The apparatuses used in the Examples are listed below.

Twin-screw extruder: trade name “ZSK-25WLE” manufactured by Coperion GmbH.

Small injection molding machines: trade name “EC75SXII” manufactured by Toshiba Machine Co., Ltd., and trade name “PS-40” manufactured by Nissei Plastic Industrial, Co. Ltd.

### <Evaluation Methods>

The evaluations of the resin compositions obtained in Examples and Comparative Examples were conducted under the following methods and conditions.

(Number Average Molecular Weight of (a-1) Component)

The pellets of the resin compositions obtained in Examples and Comparative Examples were measured using gel permeation chromatography (LC-2030C Plus manufactured by Shimadzu Corporation). A calibration curve was created using standard polystyrene and ethylbenzene, and the number average molecular weight (Mn) was determined using this calibration curve. Standard polystyrenes with molecular weights of U.S. Pat. Nos. 3,650,000, 2,170,000, 1,090,000, 681,000, 204,000, 52,000, 30,200, 13,800, 3,360, 1,300 and 550 were used. Two K-805L columns produced by Showa Denko K. K. connected in series were used as the columns. Measurements were performed with a column temperature of 40° C. and using chloroform as a solvent with a solvent flow rate of 1.0 mL/min. A 1 g/L chloroform solution was prepared as a measurement sample. The UV wavelength of the detector was set to 254 nm for measurements of standard polystyrene, and to 283 nm for measurements of the (a-1) component.

### (Glass Transition Temperature of (a) Component)

The pellets of the resin compositions obtained in Examples and Comparative Examples were measured using a DSC measuring device manufactured by PerkinElmer. In a nitrogen atmosphere, the temperature was raised from 50° C. to 300° C. at a heating rate of 20° C. per minute, was lowered to 50° C. at a rate of 20° C. per minute, and was then raised at a heating rate of 20° C. per minute to thereby measure the glass transition temperature.

### (Molding Fluidity)

The molding fluidity was evaluated by measuring the melt flow rate.

The pellets of the resin compositions obtained in Examples and Comparative Examples were pre-dried at 80° C. for 1 hour, and the melt flow rate (MFR) (g/10 min) was then measured under conditions of 250° C. and 10 kg in accordance with ISO 1133. A higher measured value indicates a better molding fluidity.

### (Impact Resistance)

The impact resistance was evaluated by measuring the Charpy impact strength.

The resin compositions obtained in Examples and Comparative Examples were fed to a screw in-line type injection molding machine (“EC75SXII” manufactured by Toshiba Machine Co., Ltd.) set at 220 to 280° C., and test specimens with dimensions specified in ISO-179 were prepared by injection molding under the condition of a mold temperature of 60 to 80° C.

Using these test specimens, the Charpy impact strength (kJ/m²) with notches was measured in accordance with ISO-179. A greater measured value indicates a better impact resistance, and a value of 10 kJ/m² or more is considered to indicate excellent impact resistance.

### (Flame Retardancy and Drip Resistance)

The flame retardancy and drip resistance were evaluated using injection-molded test specimens with a thickness of 1.5 to 3.0 mm on the basis of the UL94-5V test (bar sample).

The resin composition pellets obtained in Examples and Comparative Examples were dried at 80° C. for 1 hour. The dried pellets were fed to a screw inline type injection molding machine (trade name: “PS-40” manufactured by Nissei Plastic Industrial, Co. Ltd.) set at 185 to 300° C., and injection molded under conditions of a mold temperature of 20 to 40° C. in to bar samples with the dimensions specified in the standard (a length of 125 mm×a width of 13 mm×a thickness of 1.5 to 3.0 mm).

It should be noted that dripping becomes more likely to occur as the flowability is increased and the thickness of the bar sample is reduced, thus the thickness of the bar sample needs to be adjusted depending on flowability. The thicknesses of the bar sample were set as follows. When the MFR (g/10 min) was less than 20 g/10 min, the thicknesses were set to 2.0 mm. When the MFR (g/10 min) was 20 g/10 min or more and less than 35 g/10 min, the thicknesses were set to 2.5 mm. When the MFR (g/10 min) was 35 g/10 min or more, the thicknesses were set to 3.0 mm.

A flame of a gas burner was applied against the test specimens, and the degree of burning of the specimen was evaluated. Five bar samples were evaluated to determine the pass or fail. The pass/fail was determined as follows.

Pass: For all five bar samples, the total of combustion time and glow time after the fifth flame application was 60 seconds or less, and there was no ignition of the cotton by any falling matter from the bar sample.

Fail: There was ignition of the cotton by falling matter from the bar sample.

### <Production of Resin Composition>

### Examples 1 to 10 and Comparative Examples 1 to 8

The (a) to (d) components were fed to a twin-screw extruder in the compositions summarized in Table 1 or Table 2, and melt-kneading was conducted under the conditions of extrusion temperature of 280 to 320° C., screw rotation speed of 300 rpm, and discharge rate of 15 kg/hour to obtain resin composition pellets of each Example and Comparative Example. In the twin screw extruder, the number of barrels was 12 blocks, and, in the direction of raw material flow, an upstream feeding port was provided in the 1st barrel from upstream, a liquid addition pump was provided in the 7th barrel, and vacuum vents were provided in the 5th barrel and the 11th barrel.

Among the (a), (b), (c), and (d) components, only the component (a-3-1) was fed from a liquid addition pump, while the others were fed from the upstream feed port.

The compositions and evaluation results of the resin compositions prepared for each Example and Comparative Example are shown in Table 1 and Table 2.

TABLE 1

| | | | | Example | Example | Example | Example | Example |
|---|---|---|---|---|---|---|---|---|
| | | | | 1 | 2 | 3 | 4 | 5 |
| Composition | (a) | (a-1-1) | parts by mass | 47.5 | 47.5 | 52.0 | 52.0 | 52.0 |
| | | (a-1-2) | parts by mass | — | — | — | — | — |
| | | (a-2-1) | parts by mass | 7.0 | 7.0 | 12.5 | 12.5 | 12.5 |
| | | (a-2-2) | parts by mass | 45.5 | 45.5 | 35.5 | 35.5 | 35.5 |
| | | (a-3-1) | parts by mass | — | — | 24.0 | 24.0 | 24.0 |
| | | (a-3-2) | parts by mass | 15.5 | — | — | — | — |
| | | (a-3-3) | parts by mass | — | 11.5 | — | — | — |
| | (b) | | parts by mass | 3.5 | 3.0 | 3.5 | 6.0 | 9.0 |
| | (c) | | parts by mass | — | — | 1.5 | 1.5 | 1.5 |
| | (d) | | parts by mass | — | — | — | — | — |
| Evaluation | Number average molecular | | ×10⁴ | 1.9 | 1.9 | 1.9 | 1.9 | 1.9 |
| | weight of (a-1) component | | | | | | | |
| | Glass transition temperature | | ° C. | 104 | 114 | 102 | 103 | 103 |
| | of (a) component | | | | | | | |
| | Fluidity (melt flow rate) | | g/10 min | 44 | 23 | 43 | 39 | 35 |
| | Impact resistance | | kJ/m² | 20 | 25 | 21 | 15 | 12 |
| | (Charpy impact strength) | | | | | | | |
| | Flame retardancy (5 V test) | | — | Pass | Pass | Pass | Pass | Pass |
| | | | | Example | Example | Example | Example | Example |
| | | | | 6 | 7 | 8 | 9 | 10 |
| Composition | (a) | (a-1-1) | parts by mass | 64.0 | 64.0 | 73.0 | — | — |
| | | (a-1-2) | parts by mass | — | — | — | 80.0 | 100.0 |
| | | (a-2-1) | parts by mass | 2.0 | 2.0 | — | — | — |
| | | (a-2-2) | parts by mass | 34.0 | 34.0 | 27.0 | 20.0 | — |
| | | (a-3-1) | parts by mass | 25.0 | 25.0 | 21.0 | 14.5 | 30.0 |
| | | (a-3-2) | parts by mass | — | — | — | — | — |
| | | (a-3-3) | parts by mass | — | — | — | — | — |

| | | | | | | | |
|---|---|---|---|---|---|---|---|
| | (b) | parts by mass | 3.0 | 3.0 | 2.5 | 2.5 | 2.0 |
| | (c) | parts by mass | 4.0 | 4.0 | 4.0 | 5.0 | 23.0 |
| | (d) | parts by mass | — | 1.2 | — | — | — |
| Evaluation | Number average molecular | ×10⁴ | 1.9 | 1.9 | 1.9 | 1.6 | 1.6 |
| | weight of (a-1) component | | | | | | |
| | Glass transition temperature | ° C. | 113 | 113 | 130 | 141 | 130 |
| | of (a) component | | | | | | |
| | Fluidity (melt flow rate) | g/10 min | 29 | 28 | 10 | 12 | 14 |
| | Impact resistance | kJ/m² | 20 | 22 | 25 | 14 | 25 |
| | (Charpy impact strength) | | | | | | |
| | Flame retardancy (5 V test) | — | Pass | Pass | Pass | Pass | Pass |

TABLE 2

| | | | | Comp. | Comp. | Comp. | Comp. | Comp. | Comp. | Comp. | Comp. |
|---|---|---|---|---|---|---|---|---|---|---|---|
| | | | | Ex. 1 | Ex. 2 | Ex. 3 | Ex. 4 | Ex. 5 | Ex. 6 | Ex. 7 | Ex. 8 |
| Composition | (a) | (a-1-1) | parts by mass | 47.5 | 47.5 | 52.0 | 64.0 | 73.0 | — | — | 80.0 |
| | | (a-1-2) | parts by mass | — | — | — | — | — | 80.0 | 100.0 | — |
| | | (a-2-1) | parts by mass | 7.0 | 7.0 | 12.5 | 2.0 | — | — | — | 5.0 |
| | | (a-2-2) | parts by mass | 45.5 | 45.5 | 35.5 | 34.0 | 27.0 | 20.0 | — | 15.0 |
| | | (a-3-1) | parts by mass | — | — | 24.0 | 25.0 | 21.0 | 14.5 | 30.0 | 10.0 |
| | | (a-3-2) | parts by mass | 15.5 | — | — | — | — | — | — | — |
| | | (a-3-3) | parts by mass | — | 11.5 | — | — | — | — | — | — |

| | | | | | | | | | | |
|---|---|---|---|---|---|---|---|---|---|---|
| | (b) | parts by mass | — | — | — | — | — | — | — | — |
| | (c) | parts by mass | — | — | 1.5 | 4.0 | 4.0 | 5.0 | 23.0 | 3.0 |
| | (d) | parts by mass | — | — | — | — | — | — | — | — |
| Evaluation | Number average molecular | ×10⁴ | 1.9 | 1.9 | 1.9 | 1.9 | 1.9 | 1.6 | 1.6 | 1.9 |
| | weight of (a-1) component | | | | | | | | | |
| | Glass transition temperature | ° C. | 103 | 114 | 102 | 113 | 130 | 141 | 130 | 152 |
| | of (a) component | | | | | | | | | |
| | Fluidity (melt flow rate) | g/10 min | 48 | 26 | 47 | 31 | 11 | 13 | 15 | 3 |
| | Impact resistance | kJ/m² | 21 | 25 | 22 | 20 | 25 | 15 | 27 | 20 |
| | (Charpy impact strength) | | | | | | | | | |
| | Flame retardancy (5 V test) | — | Fail | Fail | Fail | Fail | Fail | Fail | Fail | Pass |

It can be understood that the resin compositions of Examples 1 to 10 all exhibited excellent flame retardancy, dripping prevention during combustion, and flowability, and the resin composition according to the present embodiment can be molded into molded articles with excellent flame retardancy and drip resistance during combustion.

### INDUSTRIAL APPLICABILITY

The resin composition of the present disclosure can be used as a material for electrical and electronic parts, home appliances, office automation equipment, and the like.

1. A resin composition comprising:
(a) (a-1) a polyphenylene ether-based resin, (a-2) a styrene-based resin, and (a-3) one or more compounds selected from a phosphoric acid ester-based compound and a phosphazene compound, or (a-1) a polyphenylene ether-based resin and (a-3) one or more compounds selected from a phosphoric acid ester-based compound and a phosphazene compound; and
(b) a polyarylate resin,
wherein a number average molecular weight of the (a-1) component is 1.5×10⁴ to 2.5×10⁴,
a glass transition temperature of the (a) component is 100° C. to 145° C., and
an amount of the (a-3) component is 5 to 40 parts by mass, and an amount of the (b) component is 1 to 12 parts by mass, relative to 100 parts by mass of the (a-1) component or 100 parts by mass of a total of the (a-1) component and the (a-2) component.

2. The resin composition according to claim 1, wherein
when the (a) component includes the (a-1) component and the (a-2) component,
an amount of the (a-1) component is 45 to 85 parts by mass, and an amount of the (a-2) component is 15 to 55 parts by mass, in 100 parts by mass of the total of the (a-1) component and the (a-2) component, and
the amount of the (a-3) component is 10 to 35 parts by mass per 100 parts by mass of the total of the (a-1) component and the (a-2) component.

3. The resin composition according to claim 1, wherein the (a-3) component is a phosphoric acid ester-based compound represented by the following general formula (I) or general formula (II): 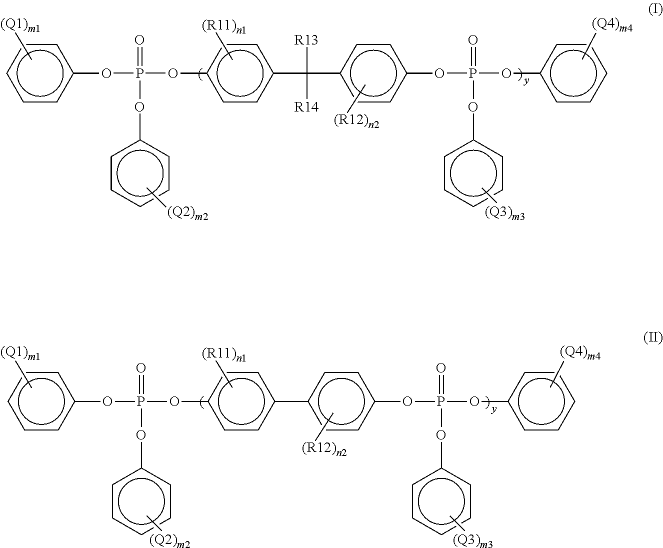
where, in the general formula (I), Q1, Q2, Q3, and Q4 independently represent alkyl groups having 1 to 6 carbon atoms, R11 and R12 represent methyl groups, and R13 and R14 are each independently a hydrogen atom or a methyl group,
in the general formula (II), Q1, Q2, Q3, and Q4 independently represent alkyl groups having 1 to 6 carbon atoms, and R11 and R12 represent methyl groups, and
in the general formula (I) and general formula (II), y is an integer of 1 or more, n1 and n2 independently represent integers of 0 to 2, and m1, m2, m3, and m4 independently represent integers of 0 to 3.

4. The resin composition according to claim 1, further comprising (c) an elastomer.

5. The resin composition according to claim 1, further comprising (d) a compatibilizer.

6. The resin composition according to claim 1, wherein a melt flow rate measured at a measurement temperature of 250° C. under a load of 10 kg in accordance with ISO 1133 is 10 g/10 min or more.

7. The resin composition according to claim 1, wherein the amount of the (a) component is 70 to 99 parts by mass in 100 parts by mass of the resin composition.

8. The resin composition according to claim 1, wherein a total amount of the (a) component and the (b) component is 70 to 100 parts by mass in 100 parts by mass of the resin composition.

9. A molded article comprising the resin composition according to claim 1.
